(19) United States
(12) Patent Application Publication
(10) Pub. No.: US 2011/0186607 A1
(43) Pub. Date: Aug. 4, 2011

(54) Hanging system for universal attachment to automobiles

(76) Inventor: Robert J. Ward, Burnsville, MN (US)

(21) Appl. No.: 12/658,016

(22) Filed: Feb. 1, 2010

(51) Int. Cl. B60R 7/08

(52) U.S. Cl. 224/275

(57) ABSTRACT

A device for hanging objects in an automobile including an elongated substantially rigid rod with a plurality of hanging element attachment points. A rod attachment portion removably attaches the rod to the head-rests of an automobile seat and supports it in a substantially horizontal position behind the automobile seat. A rod attachment loop is configured to loop around the grab handles or clothing hooks of the automobile side interior and support the rod in a second configuration. A plurality of hanging elements are removably attached to the plurality of hanging element attachment points. In an alternate embodiment, the rod is extendable from a first length to a second length, thereby accommodating variable widths of automobile interiors. The rod may further include a first, second, and third side along its length wherein each of the first and second sides includes at least two of the plurality of hanging element attachment points.

### FIELD OF THE INVENTION

The present invention relates, in general, to devices and methods for hanging or attaching structures to the interiors of automobiles and, more particularly, to devices for hanging items in an automobile with universal attachments.

### BACKGROUND OF THE INVENTION

Many foreign automobiles are not equipped with the conventional small clothing garment hooks found in most domestic automobiles and which are located near the ceiling above the rear side windows or rear portion of the vehicle. Instead, many foreign automobiles, and some domestic automobile models, have a grab bar or grab handle located near the ceiling, or on the ceiling, above the rear side windows of the vehicle. Some of these grab handles have a very small hook attached to them from which one or two, at most, wire clothes hangers may be suspended. Because the small hooks are incapable of holding a large number of garments, they are not functional for use when traveling, picking up garments from the dry cleaners, and other times when large hanging capacity is desired.

In an attempt to overcome the hanging capacity problem, vehicle owners often hang their clothing garments, on hangers, directly over and through the grab handles located in the vehicles. Due to the design and location of these grab handles in relationship to the ceiling of the vehicle, it is often difficult, and on some vehicles impossible, to pass the hook of the conventional clothes hanger through the opening between the grab handle and the ceiling (headliner) of the vehicle in which it is attached. Also, during installation and removal of the conventional clothes hangers from the grab handle, the clothes hangers, especially the ones made of wire will sometimes scrape, damage, or tear the vinyl and leather material from which the grab handles are made and also the vinyl or cloth material from which the ceiling or headliner is made. The direct contact and sliding movement of the conventional clothes hangers against the surfaces of the grab handle also has a tendency to wear, tear, crack, and damage the grab handles. For these reasons, many vehicle owners will not place (hang) clothes hangers directly over and on the grab handles in the vehicles.

Even if the vehicle owner does place conventional clothes hangers on the grab handles, the garments tend to be pushed against the windows and doors of the vehicle, due to the position of the grab handle in the vehicle, thus wrinkling and possibly soiling the garments. Since the garments hang perpendicular to the grab handle and parallel to the back of the vehicle, they also have a tendency to obstruct a good portion of the driver's view through the rear window of the vehicle and limit the useful seating capacity of the back seat.

Devices are known which can be attached to the existing clothes hooks, located in most domestic automobiles, to increase the hanging capacity. One common garment hanging device is an elongate bar which is supported at opposite ends on the existing hooks and extends from side-to-side across the rear portion of the automobile. However, this type of garment hanging device requires existing side clothes hooks, which are not provided in most foreign automobiles with grab handles, and the foreign models which do have small hooks on the grab handle locate the small and fragile plastic hooks such that the grab handles will not allow attachment of the bar, or will not support the weight of the clothing to be placed on the bar. This type of device also obstructs the drivers view through the rear window, and prevents use of the back seat for passengers. U.S. Pat. No. 2,617,571 to Hart discloses other bar type garment hanging devices.

Seidler, U.S. Pat. No. 2,528,794 and Kramer, U.S. Pat. No. 2,728,503 disclose garment hangers which require installation and adaptation to a vehicle's interior, thus allowing the hanging of clothing garments in vehicles in which no factory installed clothing hook is provided, but these hanging devices are extremely mechanical and complex in construction, and would not be practical in modern automobiles.

Shannon, U.S. Pat. No. 5,104,083 and Gabbert, U.S. Pat. No. 4,863,081 disclose garment hangers with adaptable depth adjustment mechanisms, so as to fit the various interior trim angles on which fixed garment hooks are usually located on in domestic model vehicles, but their use and adaptability to the small garment hooks often located on grab handles is impossible due to the distance at which the grab handles are located away from the trim or ceiling of the automobile.

White et al, U.S. Pat. No. 4,778,089 discloses a telescoping rod which is adapted to be supported from and beneath an interior grab handle of the vehicle. This device lacks lateral support and is subject to swinging or pivoting when garments are placed on it and the vehicle is in motion. Also, the device, due to its concentrated weight at the portion of the invention in which the adjustment brace is located, will not stay attached to the grab handle unless or until weight (garments) is placed on the opposite end of the device, thus limiting its stability. The device also requires a horizontal portion of the interior trim above the window frame to contact and support an adjustable brace. However, in the majority of foreign and domestic automobiles with interior grab handles there is no horizontal portion of the trim or, if it does exist, it is too small of an area of contact and the device has a tendency to slide off of the horizontal portion of the trim and pivot the rod end supporting the garments downward and dump the garments into the back seat of the automobile.

For reasons stated above, and for other reasons which will become apparent to those skilled in the art upon reading the present specification, there is a need for systems and methods that provide for improved hanging or attaching structures to the interiors of automobiles. There is a particular need for devices for hanging items in an automobile with universal attachments. The present invention fulfills these and other needs, and addresses deficiencies in known systems and techniques.

### SUMMARY OF THE INVENTION

A device for hanging objects in an automobile is disclosed that has an elongated substantially rigid rod with a plurality of hanging element attachment points. A rod attachment portion is configured to removably attach the elongated substantially rigid rod to the head-rests of an automobile seat and support the elongated substantially rigid rod in a substantially horizontal position behind the automobile seat. A rod attachment loop is configured to loop around the grab handles or clothing hooks of the automobile side interior and support the elongated substantially rigid rod in a substantially horizontal position behind the automobile seat. A plurality of hanging elements are removably attached to the plurality of hanging element attachment points.

In an alternate embodiment, the elongated substantially rigid rod is extendable from a first length to a second length, thereby accommodating variable widths of automobile interiors between automobile models. In particular embodiments, the elongated substantially rigid rod comprises a first side along the length of the elongated substantially rigid rod, a second side along the length of the elongated substantially rigid rod and a third side along the length of the elongated substantially rigid rod, wherein each of the first and second sides includes at least two of the plurality of hanging element attachment points configured to removably attach the hanging elements to the elongated substantially rigid rod. In further embodiments, the hanging element attachment points include a dovetail shaped opening, and wherein the hanging elements include a dovetail portion configured to matingly engage with the dovetail shaped opening. In a particular embodiment, the cross-section of the elongated substantially rigid rod is substantially triangular shaped.

The above summary of the present invention is not intended to describe each embodiment or every implementation of the present invention. Advantages and attainments, together with a more complete understanding of the invention, will become apparent and appreciated by referring to the following detailed description and claims taken in conjunction with the accompanying drawings.

### BRIEF DESCRIPTION OF THE DRAWINGS

The novel features of the invention are set forth with particularity in the appended claims. The invention itself, however, both as to organization and methods of operation, together with further objects and advantages thereof, may best be understood by reference to the following description, taken in conjunction with the accompanying drawings in which:

FIG. 1 is an interior view of an automobile having a hanging device in accordance with the present invention attached to the interior side of the automobile using attachment loops around the clothes hanger hooks on the vehicles side;

FIG. 2 is an interior view of an automobile having a hanging device in accordance with the present invention attached to the back of seats of the automobile using an attachment portion around the head rests of the automobile's seats;

FIG. 3 is a perspective view of a hanging device in accordance with the present invention;

FIG. 4 is a perspective view of an attachment hook in accordance with embodiments of the present invention;

FIG. 5 is a side view of an attachment hook in accordance with embodiments of the present invention; and

FIG. 6 is a flow chart of a method of hanging objects in an automobile interior in accordance with embodiments of the present invention.

In the following description of the illustrated embodiments, references are made to the accompanying drawings, which form a part hereof, and in which is shown by way of illustration various embodiments in which the invention may be practiced. It is to be understood that other embodiments may be utilized, and structural and functional changes may be made without departing from the scope of the present invention.

### DETAILED DESCRIPTION OF THE INVENTION

The present invention relates, in general, to devices and methods for hanging or attaching structures to the interiors of automobiles and, more particularly, to devices for hanging items in an automobile with universal attachments.

Methods and devices employing devices and methods for hanging or attaching structures to the interiors of automobiles in accordance with the present invention may incorporate one or more of the features, structures, methods, or combinations thereof described herein below. For example, devices and methods for hanging or attaching structures to the interiors of automobiles may be implemented to include one or more of the features and/or processes described below. It is intended that such a device or method need not include all of the features and functions described herein, but may be implemented to include one or more features and functions that, alone or in combination, provide for unique structures and/or functionality.

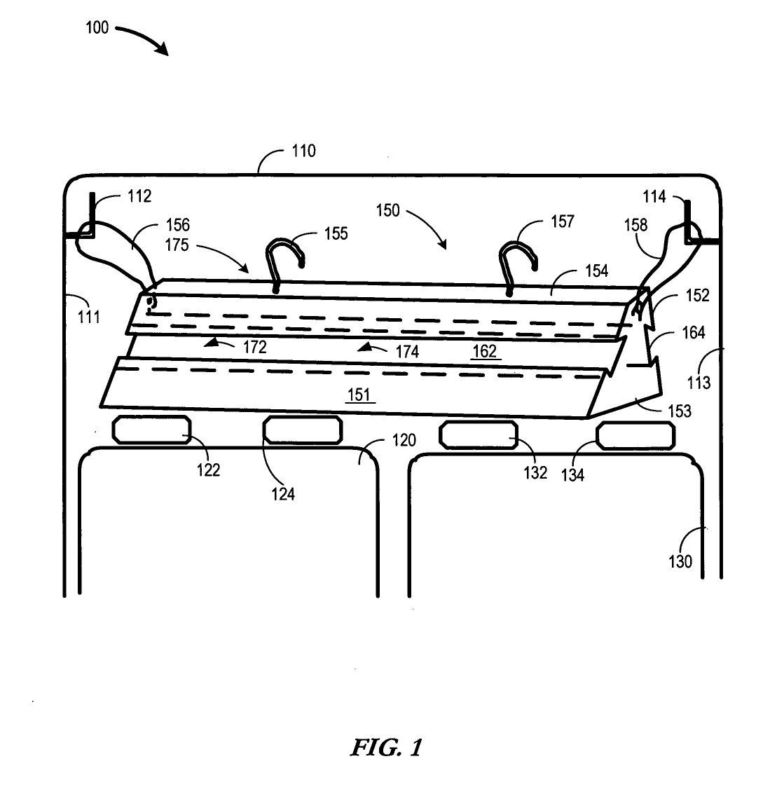

FIG. 1 is an interior view of an automobile 100 having a hanging device 150 in accordance with the present invention attached to an interior side 111 of the automobile 100 using an attachment loop 156 around a clothing hook 112 on the vehicle's side. A car body 110 includes a first interior side 111 and a second interior side 113. The first interior side 111 is illustrated with a clothing hook 112 that may alternately be a grab handle or other attachment point on the interior side of the automobile 100. The second interior side 113 is illustrated with a clothing hook 114 that may alternately be a grab handle or other attachment point on the interior side of the automobile 100. Automobile 100 is illustrated in FIG. 1 as including a first seat 120 and a second seat 130, although any number of seats may be utilized. Seat 120 is illustrated with a first headrest 122 and a second headrest 124, and seat 130 is illustrated with a first headrest 132 and a second headrest 134, although any number of headrests may be associated with a particular seat. Hanging device 150 has an elongated substantially rigid rod 175 with a plurality of hanging element attachment points, for example, points along a dovetail rail 162 and a dovetail rail 164. A rod attachment portion 155 is configured to removably attach the elongated substantially rigid rod to head-rest 122 and/or 124 of an automobile seat 120 and support the elongated substantially rigid rod 175 in a substantially horizontal position behind the automobile seat 120. A rod attachment portion 157 is configured to removably attach the elongated substantially rigid rod to head-rest 132 and/or 134 of an automobile seat 130 and support the elongated substantially rigid rod 175 in a substantially horizontal position behind the automobile seat 120. A rod attachment loop 158 is configured to loop around the grab handles or a clothing hook 114 of the automobile 100 side interior 113 and support the elongated substantially rigid rod 175 in a substantially horizontal position behind an automobile seat 130. A plurality of hanging elements may be removably attached to the plurality of hanging element attachment points as will be further described below.

In an alternate embodiment, the elongated substantially rigid rod 175 is extendable from a first length to a second length, thereby accommodating variable widths of automobile interiors between automobile models. In particular embodiments, the elongated substantially rigid rod 175 comprises a first side 151 along the length of the elongated substantially rigid rod 175, a second side 152 along the length of the elongated substantially rigid rod and a third side 153 along the length of the elongated substantially rigid rod, wherein each of the sides 151 and 152 includes at least two of the plurality of hanging element attachment points configured to removably attach the hanging elements to the elongated substantially rigid rod, for example a hanging element attachment point 172 and a hanging element attachment point 174 in the dovetail rail 162. In particular embodiments, the hanging element attachment points 172 and 174 are included in the dovetail shaped opening 162 or 164, for example, and the hanging elements include a dovetail portion configured to matingly engage with the dovetail shaped opening as will be illustrated in FIG. 5 below. In a particular embodiment, the cross-section of the elongated substantially rigid rod is substantially triangular shaped. Although a fourth side 154 is illustrated in the substantially rigid rod 175 illustrated in FIG. 1, it is evident that sides 151, 152 and 153 are substantially triangularly shaped.

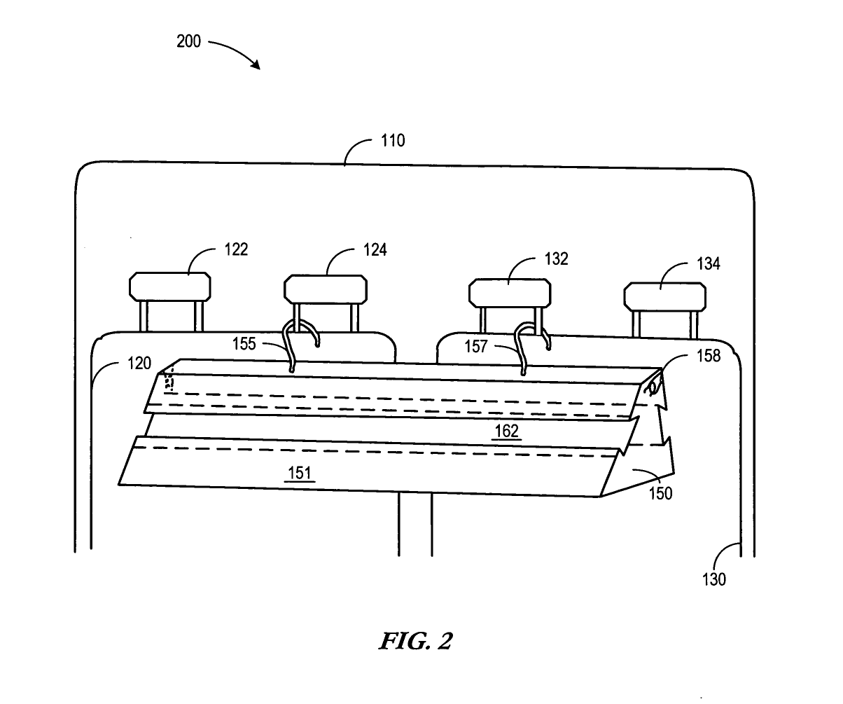

FIG. 2 is an interior view of automobile 100 having the hanging device 150 in accordance with the present invention attached to the back of seats 120, 130 of the automobile 100 using attachment portion 155 around the head rest 124 of the seat 120 and attachment portion 157 around the head rest 132 of the automobile seat 130. The rod attachment loop 158 is illustrated in FIG. 2 wrapped behind the hanging device 150, however it is contemplated that the rod attachment loop 158 and attachment loop 156 may be removable, may be extendable from within the elongated substantially rigid rod 175, or have alternate attachment designs such as hooks, clasps, or other suitable configurations to attach the hanging device 150 to the sides of the automobile 100.

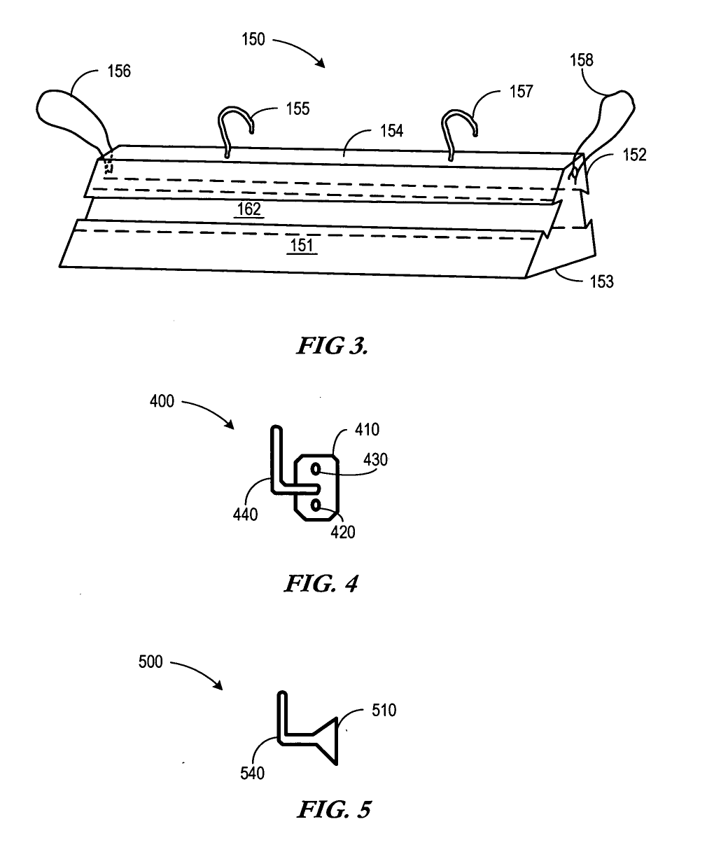

FIG. 3 is a perspective view of hanging device 150 in accordance with the present invention. Hanging device 150 has elongated substantially rigid rod 175 that may be manufactured, for example, from wood, plastic, or other suitable material. For example, the elongated substantially rigid rod 175 may be extruded from a die from polyvinylchloride or other suitable thermoplastic. The plurality of hanging element attachment points may be configured from holes drilled into the elongated substantially rigid rod 175 at multiple locations for insertion of pins, screws, nails, or other suitable attachment devices. Rod attachment portion 155 and 157 may be manufactured from, for example, stainless steel, painted or coated mild steel, or may be formed from a suitable thermoset plastic such as, for example, fiber-reinforced nylon or other suitable material. Rod attachment loop 158 may be manufactured from stainless steel cable, nylon monofilament, rope, or other material suitable for connecting the hanging device 150 to the hooks or grab handles or other attachment portions of the inside of automobile 100.

FIG. 4 is a perspective view of an attachment hook 400 in accordance with embodiments of the present invention. The attachment hook 400 includes an attachment plate 410 having a screw hole 430 and a screw hole 420. The screw holes 420, 430 may be used by inserting screws (not shown) through the holes 420, 430 to mount multiple attachment hooks 400 to multiple desired locations on the elongated substantially rigid rod 175 (see FIG. 3.) Alternately, pins may be provided to insert through the holes 420, 430 and insert into pre-drilled holes in the elongated substantially rigid rod 175. It is understood that other attachment mechanisms may be utilized without departing from the scope of the present invention.

FIG. 5 is a side view of an attachment hook 500 in accordance with embodiments of the present invention. The hook 500 is illustrated with a dovetail 510 and a hook portion 540. The dovetail 510 may be configured to matingly engage with the dovetail shaped opening 162 illustrated in FIG. 3, for example. The hook portion 540 is illustrated as a 90 degree hook, but may be round or other shape and may encompass any angle from straight through a closed 360 degree loop. The hook 500 may be manufactured from metal, plastic, composite, or other suitable material. For example, the hook 500 may be injection molded plastic.

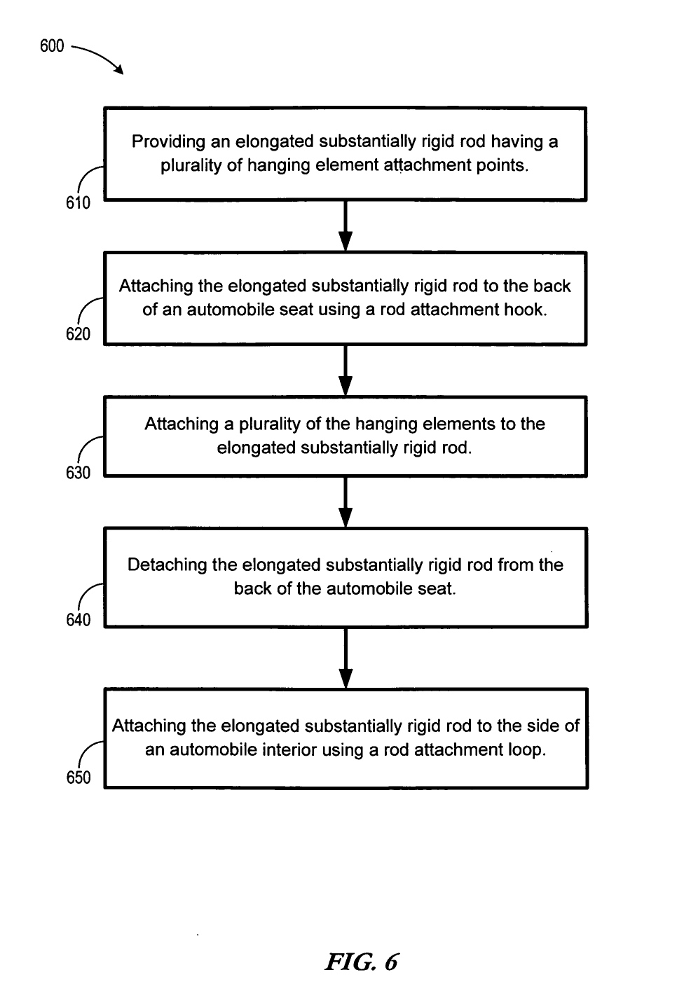

FIG. 6 is a flow chart of a method 600 of hanging objects in an automobile interior in accordance with embodiments of the present invention. The method 600 involves providing an elongated substantially rigid rod having a plurality of hanging element attachment points 610, the rod having a rod attachment hook configured to hook around the head-rests of an automobile seat and support the elongated substantially rigid rod in a substantially horizontal position behind the automobile seat, and a rod attachment loop configured to loop around the grab handles or clothing hooks of the automobile side interior and support the elongated substantially rigid rod in a substantially horizontal position behind the automobile seat, and a plurality of hanging elements removably attached to the plurality of hanging element attachment points. The method 600 further involves attaching the elongated substantially rigid rod to the back of an automobile seat using the rod attachment hook 620. The method 600 further involves attaching a plurality of the hanging elements 630. The method 600 further involves detaching the elongated substantially rigid rod from the back of the automobile seat 640. The method 600 further involves attaching the elongated substantially rigid rod to the side of an automobile interior using the rod attachment loop 650.

It is understood that the components and functionality depicted as separate or discrete blocks/elements in the figures may be implemented in combination with other components and functionality, and that the depiction of such components and functionality in individual or integral form is for purposes of clarity of explanation, and not of limitation.

Illustrations of method steps, such as, for example, the steps illustrated in FIG. 4, show steps sequentially and in a particular order. There is no need to perform the steps in the order illustrated. Deviating from the illustrated order for some or all of the steps is contemplated by the inventor, and does not depart from the scope of the present invention.

Each feature disclosed in this specification (including any accompanying claims, abstract, and drawings), may be replaced by alternative features having the same, equivalent or similar purpose, unless expressly stated otherwise. Thus, unless expressly stated otherwise, each feature disclosed is one example only of a generic series of equivalent or similar features.

While preferred embodiments of the present invention have been shown and described herein, it will be obvious to those skilled in the art that such embodiments are provided by way of example only. Numerous variations, changes, and substitutions will be apparent to those skilled in the art without departing from the invention. Accordingly, it is intended that the invention be limited only by the scope of the appended claims.

What is claimed is:

1. A device for hanging objects in an automobile, comprising:
an elongated substantially rigid rod having a plurality of hanging element attachment points;
a rod attachment portion configured to removably attach the elongated substantially rigid rod to the head-rests of an automobile seat and support the elongated substantially rigid rod in a substantially horizontal position behind the automobile seat;
a rod attachment loop configured to loop around the grab handles or clothing hooks of the automobile side interior and support the elongated substantially rigid rod in a substantially horizontal position behind the is automobile seat; and
a plurality of hanging elements removably attached to the plurality of hanging element attachment points.

2. The device according to claim 1, wherein the elongated substantially rigid rod is extendable from a first length to a second length, thereby accommodating variable widths of automobile interiors between automobile models.

3. The device according to claim 1, wherein the elongated substantially rigid rod comprises a first side along the length of the elongated substantially rigid rod, a second side along the length of the elongated substantially rigid rod and a third side along the length of the elongated substantially rigid rod, wherein each of the first and second sides includes at least two of the plurality of hanging element attachment points configured to removably attach the hanging elements to the elongated substantially rigid rod.

4. The device according to claim 1, wherein the hanging element attachment points include a dovetail shaped opening, and wherein the hanging elements include a dovetail portion configured to matingly engage with the dovetail shaped opening.

5. The device according to claim 3, wherein the cross-section of the elongated substantially rigid rod is substantially triangular shaped.

6. The device according to claim 3, wherein the cross-section of the elongated substantially rigid rod is substantially rectangular shaped.

7. The device according to claim 1, wherein the elongated substantially rigid rod comprises a first side along the length of the elongated substantially rigid rod, a second side along the length of the elongated substantially rigid rod and a third side along the length of the elongated substantially rigid rod, wherein each of the first and second sides includes a plurality of hanging element attachment points configured to removably attach the hanging elements to the elongated substantially rigid rod, wherein the hanging element attachment points include a dovetail shaped opening, and wherein the hanging elements include a dovetail portion configured to matingly engage with the dovetail shaped opening.

8. The device according to claim 7, wherein the elongated substantially rigid rod is extendable from a first length to a second length, thereby accommodating variable widths of automobile interiors between automobile models.

9. The device according to claim 8, wherein the cross-section of the elongated substantially rigid rod is substantially triangular shaped.

10. The device according to claim 1, wherein the hanging element attachment points include openings, and wherein the hanging elements include a pin configured to matingly engage with the opening.

11. The device according to claim 1, wherein the hanging element attachment points include openings, and wherein the hanging elements include a screw configured to matingly engage with the opening.

12. A method of hanging objects in an automobile, involving:
providing an elongated substantially rigid rod having a plurality of hanging element attachment points, a rod attachment hook configured to hook around the head-rests of an automobile seat and support the elongated substantially rigid rod in a substantially horizontal position behind the automobile seat, a rod attachment loop configured to loop around the grab handles or clothing hooks of the automobile side interior and support the elongated substantially rigid rod in a substantially horizontal position behind the automobile seat, and a plurality of hanging elements removably attached to the plurality of hanging element attachment points;
attaching the elongated substantially rigid rod to the back of an automobile seat using the rod attachment hook;
attaching a plurality of the hanging elements to the elongated substantially rigid rod using the hanging element attachment points;
detaching the elongated substantially rigid rod from the back of the automobile seat;
attaching the elongated substantially rigid rod to the side of an automobile interior using the rod attachment loop.

13. A device for hanging objects in an automobile, comprising:
a rod means for substantially rigidly supporting objects;
a hook means for hooking the objects being supported onto the rod means;
a loop means for attaching the rod means to the side interior of an automobile; and
an attachment means for attaching the rod means onto the back of a seat of the automobile.

14. A device for hanging objects in an automobile, comprising:
an elongated substantially rigid rod having a plurality of hanging element attachment points;
a rod attachment portion configured to engage the head-rests of an automobile seat and support the elongated substantially rigid rod in a substantially horizontal position behind the automobile seat;
a rod attachment loop configured to loop around the grab handles or clothing hooks of the automobile side interior and support the elongated substantially rigid rod in a substantially horizontal position behind the automobile seat; and
a plurality of hanging elements removably attached to the plurality of hanging element attachment points;
wherein the elongated substantially rigid rod is extendable from a first length to a second length, thereby accommodating variable widths of automobile interiors between automobile models,
wherein the elongated substantially rigid rod comprises a first side along the length of the elongated substantially rigid rod, a second side along the length of the elongated substantially rigid rod and a third side along the length of the elongated substantially rigid rod, wherein each of the first and second sides includes at least two of the plurality of hanging element attachment points configured to removably attach the hanging elements to the elongated substantially rigid rod;
wherein the hanging element attachment points include a dovetail shaped opening, and wherein the hanging elements include a dovetail portion configured to matingly engage with the dovetail shaped opening; and
wherein the cross-section of the elongated substantially rigid rod is substantially triangular shaped.
